(19) United States
(12) Patent Application Publication
(10) Pub. No.: US 2018/0364346 A1
(43) Pub. Date: Dec. 20, 2018

(54) METHOD FOR SPECTRAL ESTIMATION OF THE CLUTTER OF A HALINE LIQUID MEDIUM

(71) Applicant: SUEZ GROUPE, Paris La Défense Cedex (FR)

(72) Inventors: Guillaume SICOT, Plouvien (FR); Nicolas THOMAS, Plouneventer (FR)

(21) Appl. No.: 16/062,663

(22) PCT Filed: Dec. 16, 2016
(86) PCT No.: PCT/FR2016/053487

§ 371 Date: Jun. 15, 2018

(30) Foreign Application Priority Data
Dec. 16, 2015 (FR) 1562550

(51) Int. Cl. G01S 13/44; G01S 7/41; G01S 13/48; G01S 13/02; G01S 7/28

(52) U.S. Cl. CPC G01S 13/449; G01S 7/41; H01Q 3/2605; G01S 13/0218; G01S 7/2813; G01S 13/48

(57) ABSTRACT

A method for spectral estimation of the clutter of a haline liquid medium received by an oceanographic radar, such as a lake, a river, a sea or an ocean, from an array of antennas including at least three antennas. The method includes forming at least two sub-arrays of antennas from the array of antennas, each of the sub-arrays including at least one antenna less than the array of antennas, calculating a beam in one direction for each sub-array of antennas, locating in azimuth all the sources included in the beam from data of the beam coming from each of the sub-arrays, estimating the energy of each of the located sources, selecting a source, referred to as preferred source, among a plurality of sources according to a predetermined criterion when the beam includes a plurality of sources.

### TECHNICAL FIELD OF THE INVENTION

This invention concerns a procedure of spectral estimation of bottom clutter of a saline (namely not null salinity) liquid environment, such as a lake, a sea or an ocean. It applies, in particular, to the field of coastal oceanographic observation by radar and extends equally to lake and river observation.

We understand by “spectral estimation” a technique for estimating the power spectral density of a signal.

The invention concerns more precisely a technique of radar signal processing applied to the sea bottom clutter received by Doppler coastal oceanographic radars to antennas networks functioning on the HF or VHF (High Frequency or Very High Frequency) electromagnetic bands, namely in the range 3 MHz and 300 MHz.

In this document we understand by “sea bottom clutter” the part of the treated radar signal originating from the backscattering of the incident radar signal by the surface of saline (namely not null salinity) liquid environment, as, for example, a lake, a river, a sea or an ocean.

In this document we understand by “HF band” the part of the radio-frequency spectrum extending from 3 MHz to 30 MHz and we understand by “VHF band” the part of the radio-frequency spectrum extending from 30 MHz to 300 MHz.

### STATUS OF THE TECHNIQUE

The costal oceanographic radars are measuring instruments currently used for characterizing spatially and temporally the parameters of sea surface, such as surface current, sea status and surface wind, to spatial resolutions situated between 10 m and 6,000 m.

These active systems generally installed on coastal premises, functioning using carrier frequencies situated between 3 MHz and 300 MHz, thus exploit the propagation of surface waves, upon sea surface, for reaching high ranges at the classic horizon of systems functioning at higher frequencies (UHF waves or higher). They include a coherent transmitter with vertical polarization, in certain cases directional, and several receivers with static antennas with vertical polarization.

The measurement of the sea surface parameters starting from these radars is based on the spectral analysis in the Doppler field of the sea bottom clutter. For each Doppler channel analyzed by these radars, the sea bottom clutter originates from a set of sources more or less spread spatially and more or less energetic depending on their position in relation to the emission radiation chart, spatial gradients of surface currents, the surface roughness (sea status), the salinity and the sea water temperature present in the observed area. Obtaining a cartography, spatially established of the interest oceanographic phenomena, thus means obtaining a cartography spatially established of the energy of the bottom clutter sources for each analyzed Doppler channel.

This cartography is done generally in three stages.

The first stage consists in the distance radar processing and at the end of which each of the radar signal receivers has a complex radar signal version sampled by distance crowns of width corresponding to the radar distance resolution (from 10 m to 6,000 m according to configurations).

The second stage performed for each distance crown consists in, with the help of a temporal series of complex signals, obtaining the energy spectral density received for each interest Doppler channel. This information is obtained for each of the radar reception antennas.

The third stage consists in obtaining the distribution in the direction of energy spectral density of the sea bottom clutter.

For certain applications, when wanting to study the water surface parameters, one of the disadvantages of existing procedures is the resolution. The data high resolution is important for studying the water surface status starting from spectral densities of bottom clutter.

Certain documents of prior art propose as well spectral estimation procedures of the bottom clutter. We know, for example, the publication GAO H T ET AL: Adaptive anti-interference technique using subarrays in HF surface wave radar», IEE PROCEEDINGS : RADAR, SONAR & NAVIGATION, INSTITUTION OF ELECTRICAL ENGINEERS, GB, vol. 151, no. 2, Apr. 9, 2004, pages 100-104, XP006021676, ISSN: 1350-2395. However, this document does not describe signals generated by an oceanographic radar.

The document US2003/058153 is as well known. However, this document does not describe signals generated from the bottom clutter of a saline (namely not null salinity) liquid environment, such as a lake, a river, a sea or an ocean.

### OBJECT OF THE INVENTION

The purpose of this invention is to remedy these disadvantages.

To this end, this invention concerns a spectral estimation procedure of the bottom clutter of a saline liquid environment by a oceanographic radar, such as a lake, a river, a sea or an ocean, starting from a network of antennas including at least three antennas.

The procedure includes the following stages:
a first stage of forming at least two sub-networks of antennas starting from a network of antennas, each of the sub-networks including at least one antenna less than the network of antennas;
a second stage of calculation of a beam in a direction for each sub-network of antennas;
a third stage of azimuth localization of all sources included in the beam, starting from beam data originating from each sub-network;
a fourth stage of estimation of the energy of each of the sources localized;
a fifth stage of selection of a source, called preferred source, among several sources, according to a pre-established criterion when the beam includes several sources.

Thanks to these provisions, the procedure allows obtaining for each analyzed Doppler channel the distribution by direction of arrival, at high resolution of direction, the energy spectral density of the bottom clutter, this in order to be able to characterize precisely and at high spatial resolution the surface parameters of a liquid environment, such as the sea (current, wind, waves) behind this bottom clutter.

In an execution mode, the second stage is reiterated for each of the sub-networks of the antennas networks.

In an execution mode, between the second stage and the third stage, the procedure includes a sixth stage of calculation of several beams by scanning for each sub-network in different directions where the gap between two directions is an angle α.

In an execution mode related to the previous one, the angle α is at least equal to 0.5°.

In an execution mode, in the third stage, the azimuth of the source is localized by a signals multiple classification algorithm.

In an execution mode, in the fourth stage, the energy is estimated by the method called Pseudo-inverse estimation.

In an execution mode, in the fourth stage, the energy is estimated by the method called Covariance vector estimation.

In an execution mode, the pre-established criterion is chosen among the following group: average energy or maximum energy.

In an execution mode, the calculation of a beam in the second stage is done starting from a beam forming technique of beam forming type.

In an execution mode, the network of antennas is formed of antennas whose closest distance between the antennas network is situated between 0.4 and 0.6 times the length of the wave generated by the radar.

An example of antennas network of this type is a linear network whose antennas are spaced regularly at 0.5 times the length of the wave generated by the radar. Another example of a network of antennas of this type is a circular network, whose antennas are placed regularly on a circle of lambda radius/(4*sin(pi/n)),lambda being the length of wave generated by the radar and n the number of antennas.

### SHORT DESCRIPTION OF THE FIGURES

Other advantages, purposes and characteristics of this invention are revealed by the following description made, for explanatory purposes and not at all limiting, with regard to the attached drawings, where:

FIG. 1 represents, as logical diagram, stages of implementation in a particular execution mode of the procedure object of this invention,

FIG. 2 represents a first stage of the procedure: the forming of sub-networks,

FIG. 3 represents a second stage of the procedure: the calculation of beams for each sub-network,

FIG. 4 represents a third and fourth stage of the procedure: the azimuth localization and the energetic estimation of sources in a beam,

FIG. 5 represents an optional fifth stage of the procedure: the selection of the sources,

FIG. 6 represents the stages of the procedure implementation in a radar system,

FIGS. 7 and 8 represent the Doppler spectral estimation made starting from 4,736 temporal samples,

FIGS. 9 and 11 illustrate an example of the measurement of the radial surface currents, on the entire HF covering in the 12 MHz band,

FIGS. 12 to 14 illustrate an example of measuring radial surface currents on the first kilometers of a HF radar covering, functioning on the 12 band, in the area of strong currents gradients.

### DESCRIPTION OF EXECUTION EXAMPLES OF THE INVENTION

In this example of execution, the Doppler costal oceanographic radars function on HF or VHF electromagnetic bands, namely between 5 MHz and 50 MHz.

This invention consists in applying a method called research of beam space DOA (Direction Of Arrival), combined with an energetic estimation solution of sources for obtaining the distribution in the direction of the energy spectral density of the sea bottom clutter.

In this document, we understand by “beam space” the space formed by the set of signals produced by the sub-sets of receivers of a multi-receivers radar system whose information contents is limited to only a part of the angular space of azimuths (360°).

We understand by “beam forming” the filtering of a signal received by multiple receivers, by applying a phase shift and a weighting on each of these receivers, with the purpose to keep only the part of the incident signal originating from a sub-set of the angular space of azimuths (360°).

Equally, we understand in this document by “DOA” a method of research of the direction of arrival, in azimuth, of an electromagnetic signal received by several receivers.

This procedure combines a solution of beams forming with a super-resolution method.

According to an execution example, the beams forming method use conventional beam forming. The super-resolution in direction method used is MUSIC (registered trademark, Multiple Signal Classification).

The conventional beam forming was developed for concentrating in one direction the emission of an electromagnetic wave. It was since then exploited for a multitude of applications among which medical imaging, defense radars and telecommunications. This technique is implemented in the WERA (WEllen Radar, registered trademark) oceanographic radar systems, in their version of linear antennas networks. We talk here about beams forming by calculation. For that, the interval of interest directions is revealed in order to obtain a set of directions to focus on. For each direction to focus on, the vector of complex signals received by the receivers of the receptor antennas linear network is convolved by a checking in vector, equally complex, simulating phase shifts (inter-antennas delays), caused by spacing of antennas, estimated for a signal originating from the targeted direction. The convolution product module made supplies an estimation of the part of incident energy coming from the targeted direction. The main interest of this method is to supply an exhaustive covering of the interest area (no gap).

The MUSIC technique is a direction of arrival research technique and was integrated for the first time in an oceanographic radar system in 1999. More recently, the technique was adapted for WERA radar systems including a higher number of receivers. The MUSIC technique consists in one breakdown in sub-spaces (signal space and noise space) of the space of signals received by all the radar receivers. It uses an estimation of inter-spectral matrix of signals of various receivers and needs to know the number of sources to be localized or to estimate it with the help of values specific to the inter-spectral matrix. It returns the originating directions of sources to be localized. The energy of each source can then be estimated by various methods, such as Pseudo inverse estimation or Covariance vector estimation. The main interest of this technique is its good direction resolution.

The interest of this procedure is to combine the advantages of the beam forming method with those of the super-resolution method.

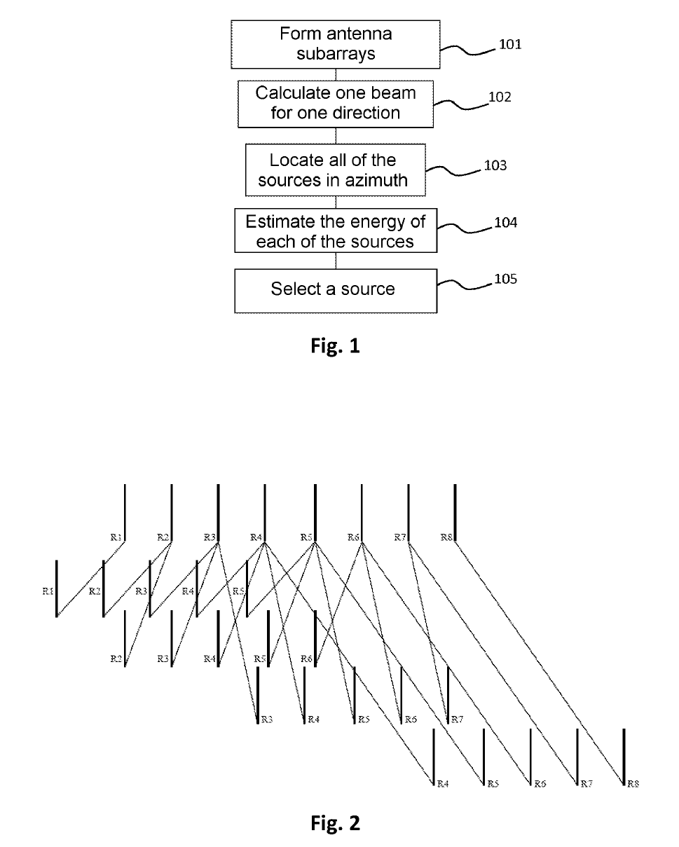

FIG. 1 represents, as logical diagram, stages implemented in a particular execution mode of the procedure object of this invention and includes:
a first stage 101 of forming sub-networks of antennas,
a second stage 102 of calculation of a beam for one direction,
a third stage 103 of azimuth localization of all sources,
a fourth stage 104 of estimating the energy of each of the sources.
a fifth stage 105, optional, of selection of a source according to a pre-established criterion when several sources exist for the same beam.

These stages are described in the description below.

In this example of execution, we limit to the oceanographic radars fitted with receiving antennas with identic receiving charts. The only difference considered between the different receiving antennas is thus their position. The only relative variations of position considered between the antennas are the variations in a horizontal plan in relation to the wave front coming from the observed maritime area.

FIG. 2 represents a first stage of the procedure: the forming of sub-networks.

Starting with the radar receiving network, noted R1 to R8, a set of sub-networks is built. In the case of linear receiving network of eight antennas, each sub-network can, for example, be formed of five antennas. We thus obtain four sub-networks.

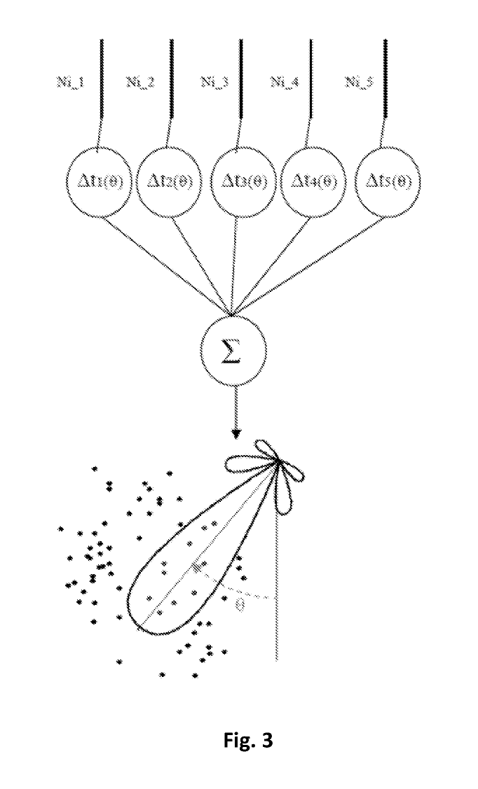

FIG. 3 represents a second stage of the procedure: the calculation of beams for one direction and for each sub-network.

The sub-networks form synthetic antennas which shall indicate successively, in full, in the various sectors of the angular area observed by the radar.

The result of the sum is represented and represents the result of a beam of the virtual network i under angle 8 containing only a part of the sources.

This checking in is carried out by a conventional beam forming using an apodization window allowing obtaining a main lobe with uniform energy with secondary lobes slightly reduced. The angular pitch between each checking in is lower to the resolution at −3 dB of the main lobe of the beams formed, thus a partial recovery in direction takes place between the different checking in beams.

This checking in constitutes a spatial filtering allowing to eliminate from the signal a part of the sources present in the angular area observed by the radar, especially the very energetic sources on which MUSIC tends to focus as a priority.

FIG. 4 represents a third and fourth stage of the procedure: the azimuth localization and the energetic estimation of sources in a beam.

For each checking in made, the complex signals received by the sub-networks (four in this example) are processed by the MUSIC algorithm. The sources S (in the figure only one source S is indicated) present in the beam indicated by the synthetic antennas are localized precisely in the direction thanks to MUSIC and their energy is estimated by the Pseudo inverse estimation method.

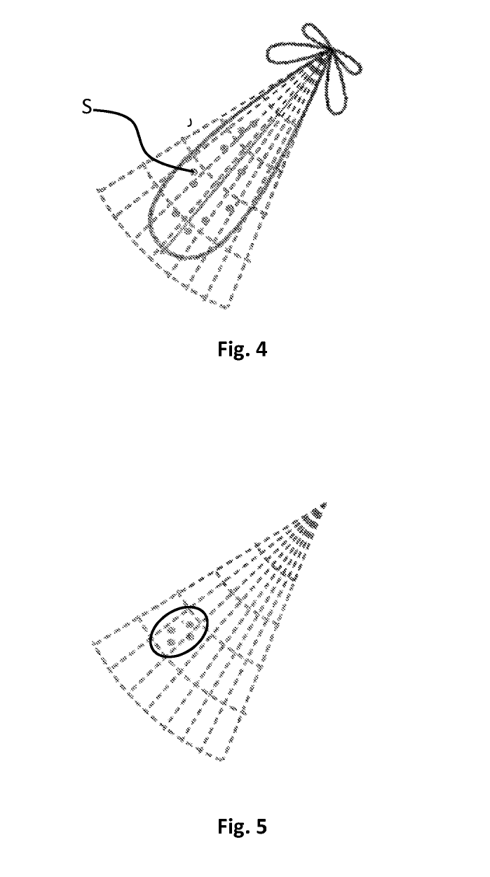

FIG. 5 represents a fifth stage of the procedure which is optional: the selection of sources.

At the end of the procedure processing, because there is partial recovery in direction between the different checking in beams, it happens that that several sources were localized by MUSIC in the same direction, in which case the pre-established criterion is the strongest energy of different sources retained.

According to other variant, the pre-established criterion is chosen from the following group: average energy or maximum energy.

The processing procedure does not supply a spectral estimation without gaps on all directions of interest, as the conventional beam forming does. It supplies however a more exhaustive covering in direction than that obtained with only the MUSIC algorithm while maintaining a high angular resolution close to that obtained by MUSIC alone.

The procedure was applied for data coming from a WERA radar system with sixteenth receiving paths.

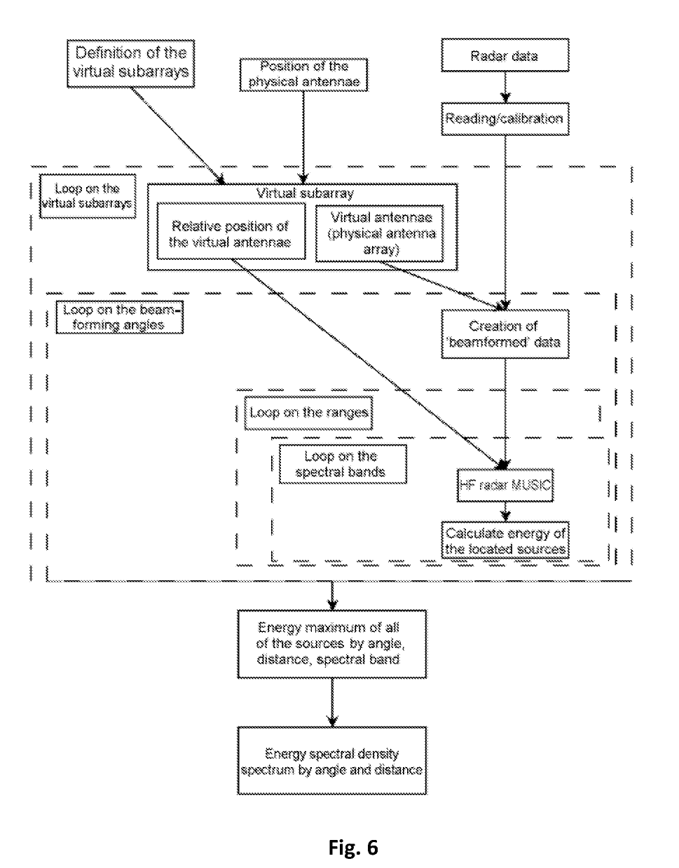

FIG. 6 represents stages of the procedure implementation in a radar system.

In this particular case, the mono-static system functioning in the 12 MHz band includes a directional emission chart of width with 130° in azimuth at −20 dB. It functions at a spatial resolution of 1.5 Km. The emission central direction is the azimuth 249°.

The sea bottom clutter of first order in this area is characterized by:
a high number of sources little spread out spatially in the first 30 kilometers of range, in particular in the most energetic area of the emission lobe. This high number of sources is due to strong spatial gradients of tide currents in this area.
a low number of sources spread out spatially in another part, because of surface currents relatively homogenous in these areas.

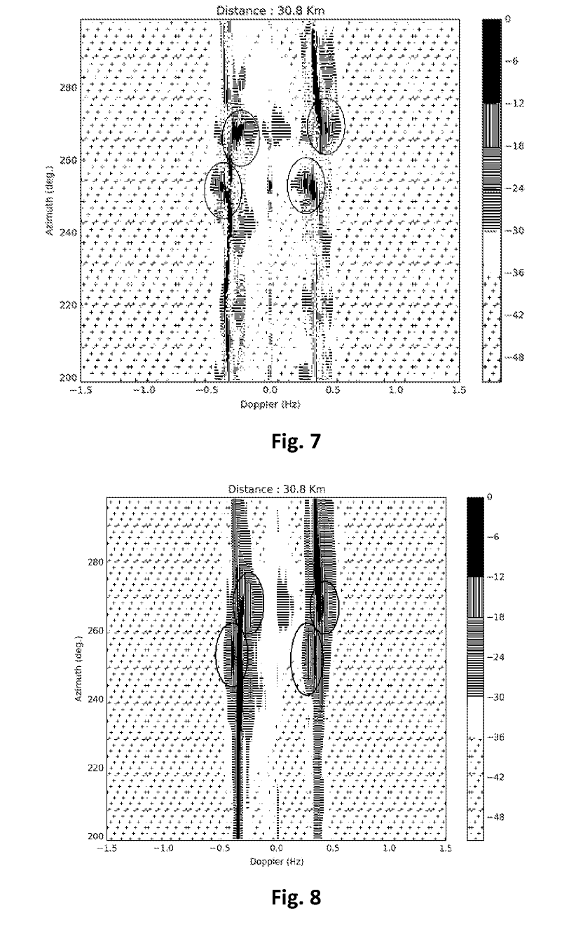

FIGS. 7 and 8 represent the Doppler spectral estimation made on the basis of 4,736 temporal samples, at the 30.8 Km case distance for the procedures:
according to an example of execution of the invention with 5 sub-networks of 12 receivers, see FIG. 7;
according to an example of execution of prior art with the help of conventional beam forming with 16 receivers, see FIG. 8.

The circles indicate an improvement of the azimuth resolution of energetic structures.

FIGS. 7 and 8 highlight the gain in azimuth resolution, higher than coefficient 2, obtained with the example of execution of the invention in this configuration.

An application example is the study of costal currents with high spatial resolution and thus likely to be integrated in a costal oceanographic radar system dedicated to cartography in real time at high resolution of surface currents.

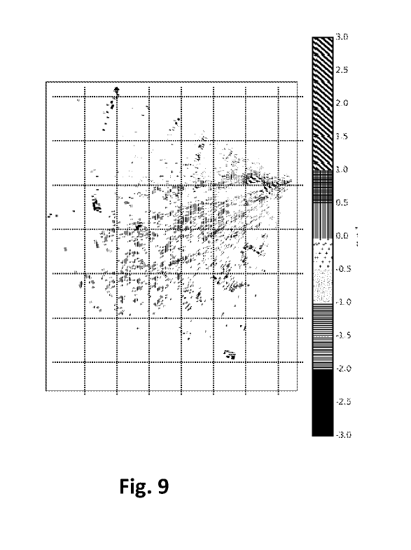

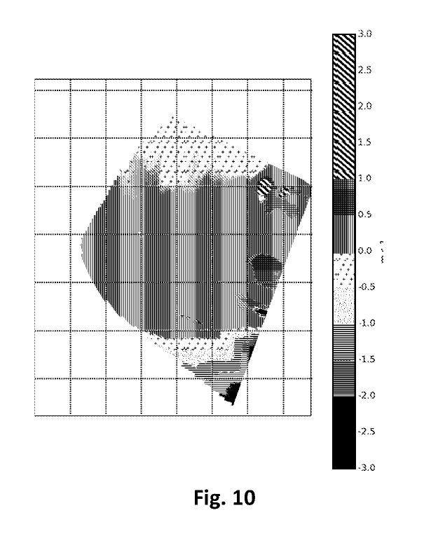

FIGS. 9 to 11 illustrate an example of measuring radial surface currents on the entire HF covering, functioning on the 12 MHz band.

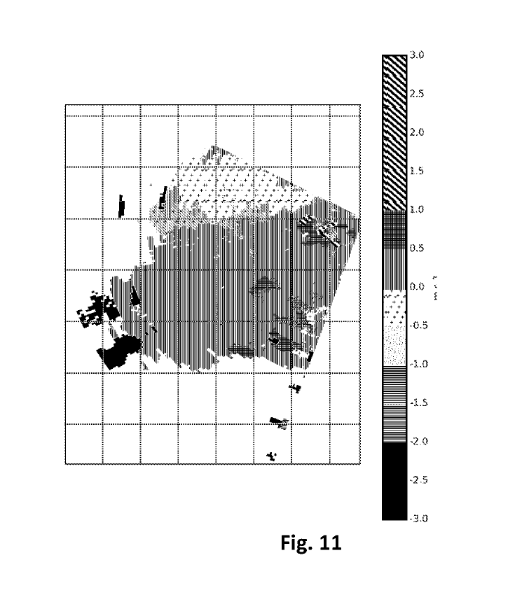

FIG. 9 represents a procedure stage of the prior art with breakdown in only MUSIC sub-spaces. FIG. 10 represents a procedure stage of the prior art with the help of beam forming alone. FIG. 11 illustrates a procedure stage according with an execution example.

Generally, Beam forming has the disadvantage of being little determined in direction, even when exploiting the maximum number of receivers typically used for oceanographic radars (16 currently). In point of fact, in the case of a receiving linear network distanced regularly with half-length of wave, and under rectangular apodization of signals of 16 receivers, the best azimuth resolution, at −3 dB, reached for an orthogonal viewing direction at the antenna network is 6°. For a viewing direction of 45° it reaches 9°. At 20 Km from the radar, this resolution corresponds to an azimuth resolution higher than 3 Km, namely superior to the majority of distance resolutions implemented on the oceanographic HF radars.

Generally, the method of breakdown in MUSIC sub-spaces presents itself the disadvantage of being very sensitive to the energy of the sources. In the case of the directional transmitter or a strong dynamics of the energy of the sources along the angular dimension, this disadvantage manifests through an over-concentration of sources in a part of the observed angular sector, area where the sources are the most energetic, which greatly degrades the coverage ratio, especially at the edge of the emission lobe. The spectral estimation made includes a weak filling ratio that makes necessary the use of an interpolator in post-processing.

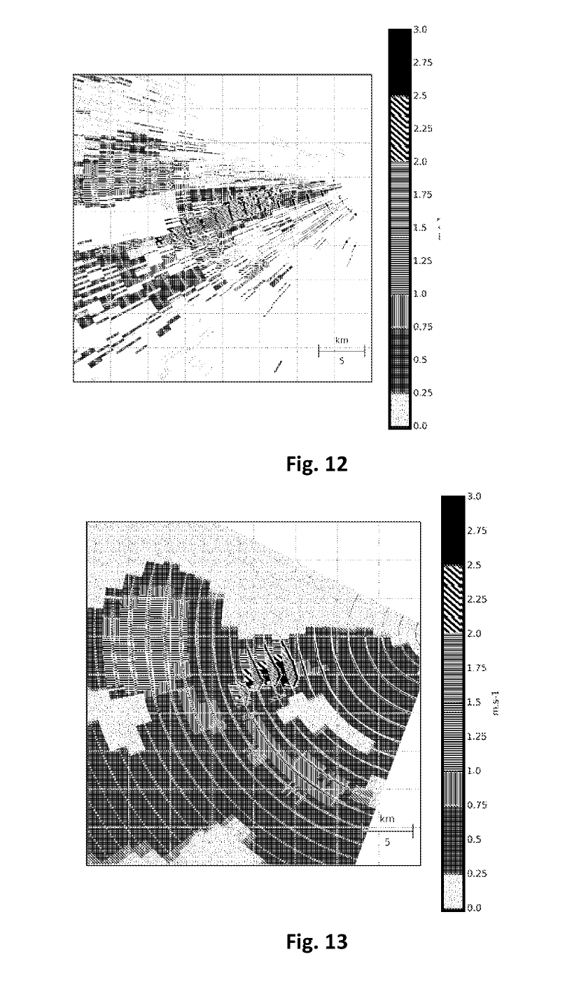

FIGS. 12 to 14 illustrate an example of measuring radial surface currents on the first kilometers of a HF radar covering, functioning on the 12 MHz band, in the area of strong currents gradients.

FIG. 12 represents a procedure stage of the prior art with the help of breakdown in only MUSIC sub-spaces.

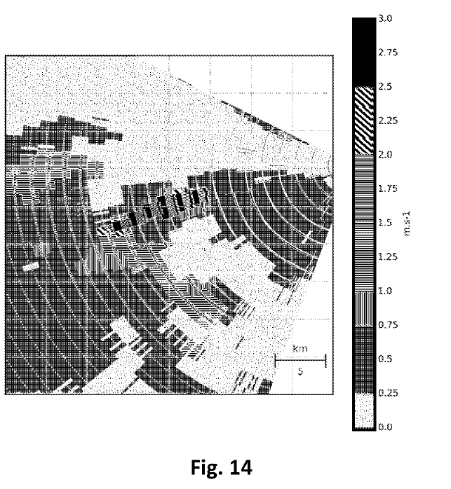

FIG. 13 represents a procedure stage of the prior art with the help of beam forming alone. FIG. 14 illustrates a procedure stage according to an execution example.

FIGS. 11 and 14 highlight that the spatial resolution of measurements and the spatial covering ratio are increased in relation to previous solutions.

Among the industrial applications that use the study of costal currents at high spatial resolution we can mention:
Industry of MRE (acronym of marine renewable energies) : i) water: evaluation of the producible resource and positioning optimization of marine turbines (development stage), ii) support of sea operations of installation and maintenance of a MRE field (construction and exploitation stages), iii) contribution to the short term forecasting of producible resources (exploitation stage)
Offshore oil and gas industry: i) security and optimization of operations at sea, ii) support for the environment crisis management. Integrated in a HF oceanographic radar, the spatial resolution obtained thanks to this procedure allows to localize on a long range the currents induced by phenomena of “internal waves” type likely to disrupt the offshore maritime operations.
Port: security and optimization of operations at sea: Integrated in a HF or VHF oceanographic radar, the procedure allows increasing the spatial resolution of surface currents maps used for the validation of costal hydrodynamic models.

1. A procedure of spectral estimation of bottom clutter of saline liquid environment by an oceanographic radar, such as a lake, a river, a sea or an ocean, on the basis of a network of antennas including at least three antennas, the procedure comprises the following stages:
a first stage of forming at least two sub-networks of antennas on the basis of a network of antennas, each of the sub-networks including at least one antenna less than the network of antennas;
a second stage of calculation of a beam in a direction for each sub-network of antennas;
a third stage of azimuth localization of all sources, included in the beam on the basis of the data of the beam coming from each of the sub-networks;
a fourth stage of estimation of the energy of each of the localized sources; and
a fifth stage of selection of one source, called preferred source, among several sources according to a pre-established criterion when the beam includes several sources.

2. The procedure according to claim 1, where the second stage is reiterated for each of the sub-networks of the network of antennas.

3. The procedure according to claim 1, where between the second and third stage, the procedure includes a sixth stage of calculation of several beams by scanning for each sub-network in different directions, the gap between two directions is the angle α.

4. The procedure according to claim 3, where the angle α is at least equal to 0.5°.

5. The procedure according to claim 1, where at the third stage the azimuth of the source is localized by a signals multiple classification algorithm (MUSIC).

6. The procedure according to claim 1, where at the fourth stage the energy is estimated by the method called Pseudo inverse estimation.

7. The procedure according to claim 1, where at the fourth stage the energy is estimated by the method called Covariance vector estimation.

8. The procedure according to claim 1, where the pre-established criterion is chosen among the following group: average energy or maximum energy.

9. The procedure according to claim 1, where the calculation of the beam of the second stage is done on the basis of a beam forming technique of beam forming type.

10. The procedure according to claim 1, where the antenna network is formed of antennas where the closest distance between the antennas of the network is included between 0.4 and 0.6 times the length of the wave generated by the radar.
